(19) United States
(12) Patent Application Publication
(10) Pub. No.: US 2026/0039953 A1
(43) Pub. Date: Feb. 5, 2026

(54) CONTROL APPARATUS AND CONTROL METHOD THEREFOR

(71) Applicant: CANON KABUSHIKI KAISHA, Tokyo (JP)

(72) Inventor: HIROFUMI HONDA, Tokyo (JP)

(21) Appl. No.: 19/277,797

(22) Filed: Jul. 23, 2025

(30) Foreign Application Priority Data
Jul. 31, 2024 (JP) 2024-124835

(51) Int. Cl. H04N 23/663

(52) U.S. Cl. CPC H04N 23/663

(57) ABSTRACT

A control apparatus drives a movable part using a motor. The control apparatus receives absolute position information on an output shaft that is a rotation axis of the movable part; receives relative position information on a motor shaft that is a rotation axis of the motor; generates correction data corresponding to a plurality of positions of the output shaft based on the absolute position information and the relative position information; sets an origin position of the relative position information based on the absolute position information; and generates a drive signal for the motor using the relative position information based on the origin position. The setting unit sets the origin position based on corrected position information in which the absolute position information is corrected based on the correction data.

### BACKGROUND

### Field of the Technology

The present disclosure relates to a position control technology for a motorized camera platform.

### Description of the Related Art

Remote cameras that can control a capturing direction in a pan/tilt direction by remote operation are used. Remote cameras have been widely used from surveillance cameras to video production. In video production, high-accuracy pan and tilt position control is required. Japanese Patent No. 4599273 (Patent Document 1) proposes a technique for reducing a pan/tilt positional error by moving to a home position and resetting a step counter. Japanese Patent Laid-Open No. 7-230031 (Patent Document 2) proposes a technique for eliminating, by using a pulse encoder in combination, a linearity error, which is a problem when a potentiometer is used as a position detection method.

However, in Patent Document 1, in order to eliminate the positional error of the camera platform, it is necessary to temporarily move to the home position and reset the step counter. In this case, unintended movement of the camera platform occurs. Furthermore, there is a problem that the pan and tilt positions need to be set again. Patent Document 2 has a problem that a potentiometer generally has low resolution and cannot obtain position detection accuracy equal to or more than the resolution.

### SUMMARY

The present disclosure provides a technology that enables high-accuracy position control of a motorized camera platform.

A control apparatus that drives a movable part using a motor, the control apparatus comprises: a first reception unit that receives absolute position information on an output shaft that is a rotation axis of the movable part; a second reception unit that receives relative position information on a motor shaft that is a rotation axis of the motor; a generation unit that generates correction data corresponding to a plurality of positions of the output shaft based on the absolute position information and the relative position information; a setting unit that sets an origin position of the relative position information based on the absolute position information; and a drive signal generation unit that generates a drive signal for the motor using the relative position information based on the origin position, wherein the setting unit sets the origin position based on corrected position information in which the absolute position information is corrected based on the correction data.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view illustrating a configuration of a remote camera.

FIG. 2 is a view describing an initialization process of a motor encoder.

FIG. 3 is a view describing a linearity error of an output shaft encoder.

FIG. 4 is a view describing a process of a tilt (pan) correction unit.

FIG. 5 is a flowchart showing the process of the tilt (pan) correction unit.

FIG. 6 is a view describing an averaging process in small sections in the tilt (pan) correction unit.

FIG. 7 is a flowchart showing a process of a tilt (pan) setting unit.

FIG. 8 is a view describing linear interpolation in the tilt (pan) setting unit.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

As a first embodiment of a control apparatus according to the present disclosure, a remote camera that can change a capturing direction in a pan/tilt direction will be described below as an example.

### Apparatus Configuration

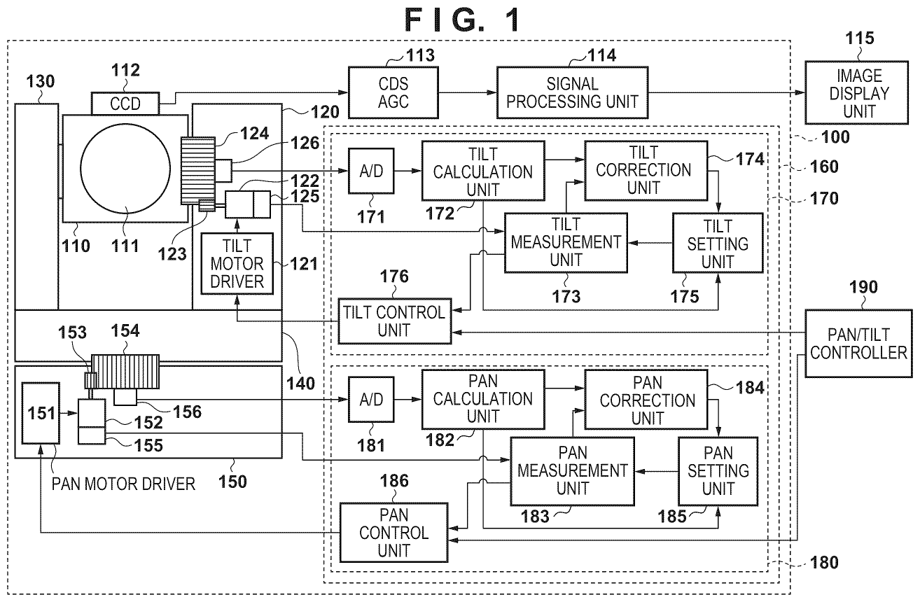

FIG. 1 is a view illustrating a schematic configuration of a remote camera 100. The remote camera 100 includes a camera head 110, camera head support units 120 and 130, a turntable 140, a bottom case 150, and a microcomputer processing unit 160 that performs pan/tilt drive control.

The camera head 110, which is an image capturing apparatus, includes a lens unit 111 and a charge-coupled device (CCD) sensor 112. An output of the CCD sensor 112 is converted into a video signal via a correlated double sampler (CDS)/automatic gain control (AGC) circuit 113 and a signal processing unit 114, and is output to an image display unit 115 that is externally connected.

The camera head support unit 120 also serves as a drive unit that drives the camera head 110 in the tilt direction. A motor 122 (tilt drive motor) is driven by a motor drive signal generated by a motor driver 121. A motor shaft of the motor 122 includes a motor gear 123, and when the motor 122 rotates, a driving gear 124 meshing with the motor gear 123 rotates. As a result, a rotation axis of the driving gear 124 serves as an output shaft to drive the camera head 110 in the tilt direction.

A motor encoder 125 generates a pulse signal in response to rotation of the motor shaft of the motor 122. Here, it is assumed that the motor encoder 125 is an incremental encoder (relative value encoder). On the other hand, an output shaft encoder 126 detects a position (phase angle) of the driving gear 124, which is a rotation axis (output shaft) in the tilt direction of the camera head 110. Here, an absolute encoder (absolute value encoder) is adopted as the output shaft encoder.

Examples of the absolute value encoder include a potentiometer having a simple structure and an optical or magnetic linear encoder that accurately obtains an absolute value by a combination of a plurality of periodic signals. While any encoder can achieve the present embodiment, a form using an optical linear encoder that obtains an absolute value by a combination of sine wave signals having three types of periods of upper, middle, and lower will be described below. The sine wave signal is a two-phase signal (SINΘ and COSΘ) with a phase errored by 90°. Therefore, this is converted into angle information by performing arc tangent (ATAN(SINΘ/COSΘ)) conversion, and absolute position information (phase angle) can be obtained by combining the three types of angle information of upper, middle, and lower.

The bottom case 150 also serves as a drive unit that drives the camera head 110 in the pan direction. A motor 152 (pan drive motor) is driven by a motor drive signal generated by a motor driver 151. A motor shaft of the motor 152 includes a motor gear 153, and when the motor 152 rotates, the rotation is transmitted to a driving gear 154 meshing with the motor gear 153. As a result, a rotation axis of the driving gear 154 serves as an output shaft to drive the turntable 140 in the pan direction.

A motor encoder 155 generates a pulse signal in response to rotation of the motor 152. An output shaft encoder 156 detects a position (phase angle) of the driving gear 154, which is a rotation axis (output shaft) in the pan direction of the camera head 110. Here, an absolute value encoder is adopted similarly to the motor encoder 125 for tilt.

The microcomputer processing unit 160 includes a control block 170 for tilt position control and a control block 180 for pan position control. A pan/tilt (PT) controller 190 is a control apparatus to be externally connected, and outputs, to the microcomputer processing unit 160, a command for instructing a target position in the pan and tilt directions in accordance with an instruction input by an operator. Note that the microcomputer processing unit 160 is assumed to be configured by an application specific integrated circuit (ASIC), but some or all of the functions may be implemented by software. In that case, the microcomputer processing unit 160 includes, as components, a central processing unit (CPU), a random access memory (RAM), and a read-only memory (ROM) storing a program.

First, a process of the control block 170 that controls the tilt direction will be described. As the camera head 110 moves in the tilt direction, a detection signal is output from the output shaft encoder 126. The detection signal is received and quantized by an analog/digital (A/D) converter 171, and position information (phase angle of the output shaft) in the tilt direction is calculated by a tilt calculation unit 172. The position information in the tilt direction is multiplied by a conversion coefficient kₜᵢₗₜ for aligning with the coordinate system of the motor encoder and output. The conversion coefficient kₜᵢₗₜ is calculated as a ratio of the resolution of the motor encoder 125 to the resolution of the output shaft encoder 126 when the camera head (=tilt output shaft) rotates by a unit angle.

On the other hand, the pulse signal output from the motor encoder 125 is received and counted by a tilt measurement unit 173, and the relative position information (rotation angle) of the motor 122 is calculated from the number of counts. The coordinate origin position of the rotational position of the motor is set via a tilt correction unit 174 and a tilt setting unit 175. The setting process of the origin position coordinate will be described later. A tilt control unit 176 generates and outputs, to the motor driver 121, a motor drive signal by comparing the target position instructed from the pan/tilt controller 190 with the rotational position of the motor 122 measured by the tilt measurement unit 173.

Next, the process of the control block 180 that controls the pan direction will be described. As the camera head 110 moves in the pan direction, a detection signal is output from the output shaft encoder 156. The detection signal is received and quantized by an A/D converter 181, and position information (phase angle of the output shaft) in the pan direction is calculated by a pan calculation unit 182. The position information in the pan direction is multiplied by a conversion coefficient kₚₐᵢₘ for aligning with the coordinate system of the motor encoder and output. The conversion coefficient kₚₐₙ is calculated as a ratio of the resolution of the motor encoder 155 to the resolution of the output shaft encoder 156 when the camera head (=pan output shaft) rotates by a unit angle.

On the other hand, the pulse signal output from the motor encoder 155 is received and counted by a pan measurement unit 183, and the rotation angle of the motor 152 is calculated from the number of counts. The coordinate origin position of the rotational position of the motor is set via a pan correction unit 184 and a pan setting unit 185. The setting process of the origin position coordinate will be described later. A pan control unit 186 generates and outputs, to the motor driver 151, a drive signal for the motor by comparing the target position instructed from the pan/tilt controller 190 with the rotational position of the motor 152 measured by the pan measurement unit 183.

### Coordinate Setting of Motor Rotational Position

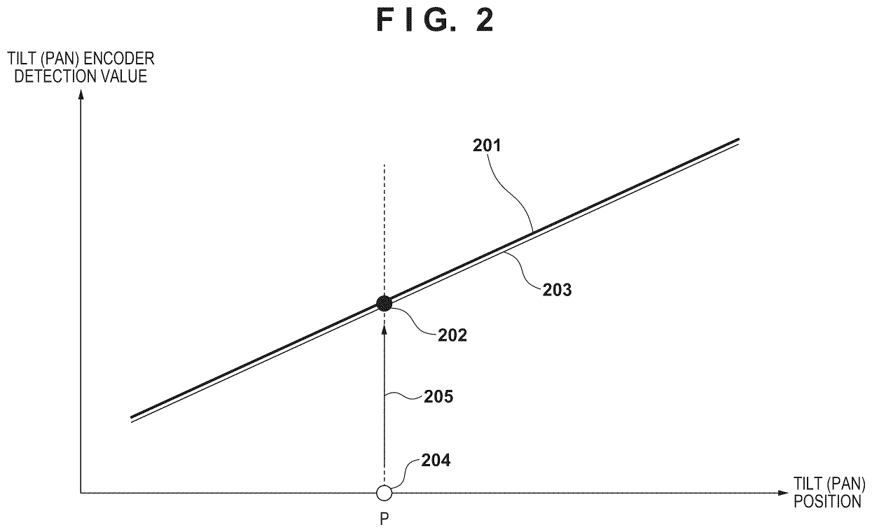

Next, coordinate setting of the motor rotational position will be described. Note that since the processes in the tilt direction and the pan direction are similar, the tilt direction will be described below, and the description of the pan direction will be omitted. Note that in FIGS. 2 to 7, difference parts in the pan direction are illustrated in parentheses.

FIG. 2 is a view describing a concept of an initialization process of the motor encoder. The initialization process is a process of setting the coordinate origin position of the motor encoder based on an output value of the output shaft encoder. While FIG. 2 illustrates the output shaft and the encoder detection value of the motor regarding the tilt direction, the same applies to the pan direction. In FIG. 2, the horizontal axis represents the tilt position (phase angle), and the vertical axis represents the encoder detection value.

A solid line 201 indicates a characteristic of the output shaft encoder. For example, when the remote camera 100 is powered on in the attitude of a tilt position P, the tilt calculation unit 172 outputs position information 202 in the tilt direction corresponding to the tilt position P. On the other hand, since the tilt measurement unit 173 is a relative value counter that measures pulse signals, the counter value is “0” as indicated by an initial value 204 when the power is on. Therefore, in the initialization process indicated by an arrow 205, the coordinate origin position of the motor encoder is set to the position information calculated by the tilt calculation unit 172. When the coordinate origin position is set, the motor encoder 203 measures position information (position coordinate) in the same coordinate system as the characteristic 201 of the output shaft encoder 126 as indicated by a characteristic 203 (converted position information) converted into an absolute position in accordance with the rotation angle (movement of the tilt position). Note that FIG. 2 illustrates the characteristic 201 and the characteristic 203 that are erred for the sake of explanation.

However, it is known that a linearity error (difference) occurs in absolute position information (phase angle) obtained by the absolute value encoder in general. That is, in the present embodiment, since the absolute value encoder is used as the output shaft encoder, a linearity error occurs in a detection value of the output shaft encoder.

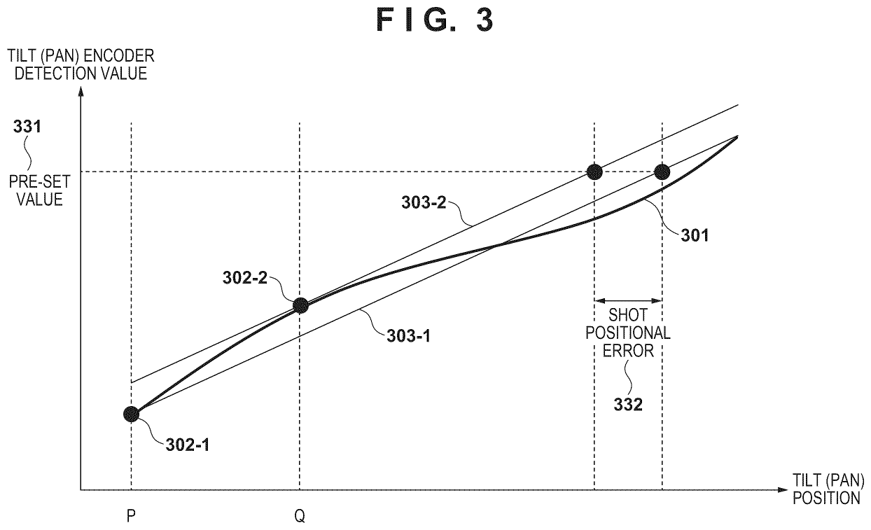

FIG. 3 is a view describing a linearity error of the output shaft encoder. A curve 301 indicates output characteristics of an output shaft encoder having an error. In this case, the output of the position information in the tilt direction when the power is on in the attitude of the tilt position P is a point 302-1, and in a case where the above-described initialization process is performed at this position, the characteristic of the motor encoder corresponding to movement of the tilt position is as indicated in a characteristic 303-1. On the other hand, the output of the position information in the tilt direction when the power is on in the attitude of a tilt position Q is a point 302-2, and in a case where the above-described initialization process is performed at this position, the characteristic of the motor encoder corresponding to movement of the tilt position is as indicated in a characteristic 303-2.

Therefore, the coordinate of the motor encoder errs depending on the position in the tilt direction at the time point when the power is turned on. As a result, a positional error occurs in a shot function (function of setting the attitude of the camera to a preset position). For example, the position of the motor encoder is preset at a point 331 in a situation where the power is turned on at the point P. Once the power is turned off, the power is turned on again at the point Q, and when the camera head 110 is moved to the preset position by the shot function, a shot positional error 332 occurs due to the error of the motor encoder.

Therefore, in the first embodiment, the correction data is calculated by the tilt correction unit 174 (and the pan correction unit 184), and the motor coordinate is corrected using the correction data by the tilt setting unit 175 (and the pan setting unit 185). This can correct the error in the absolute value in the output shaft encoder, and highly accurately set the shot position.

### Apparatus Operation

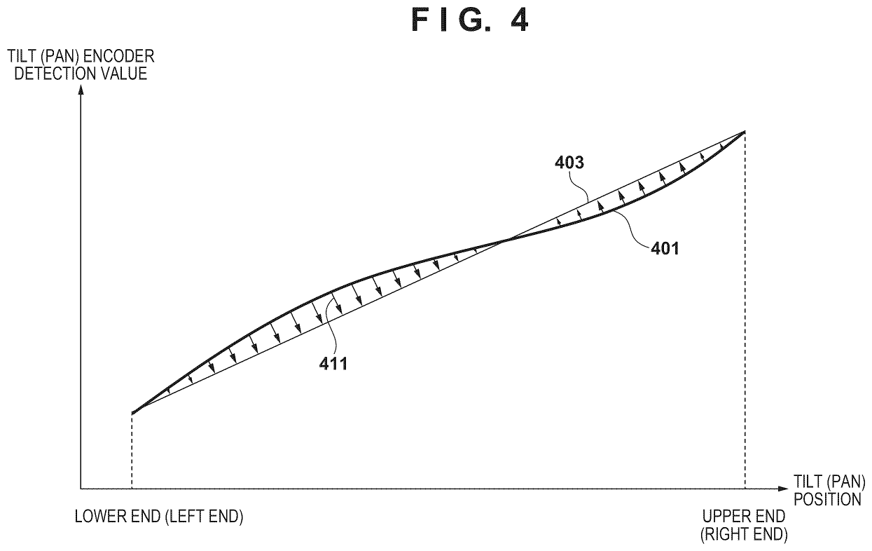

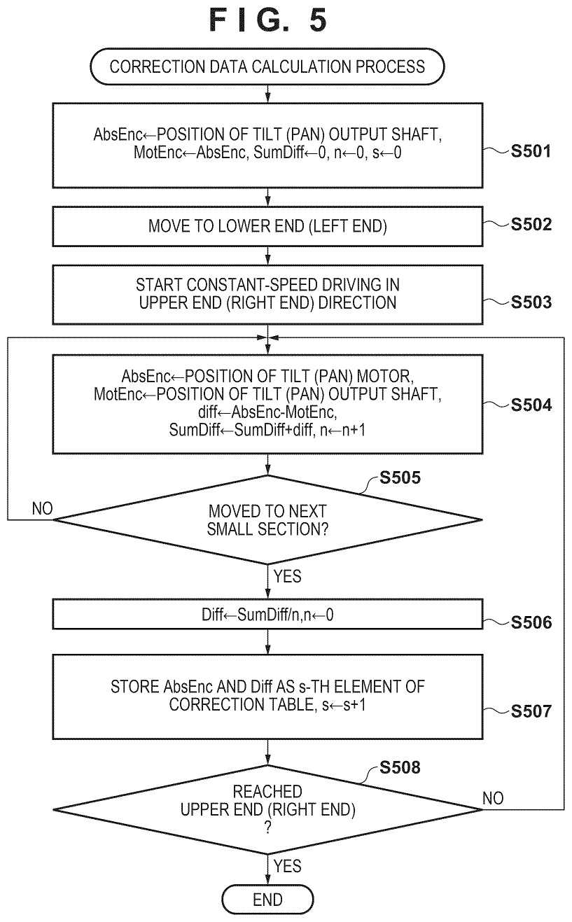

Hereinafter, a calculation method for correction data will be described with reference to FIGS. 4 and 5. Note that since the processes in the tilt direction and the pan direction are similar, the tilt direction will be described below.

FIG. 4 is a view describing a calculation process of correction data in the tilt (pan) correction unit. The calculation process of the correction data is performed prior to installation and/or capturing of the remote camera, and performed in an operation mode such as an adjustment mode in the remote camera 100, for example.

In the adjustment mode, the tilt correction unit 174 calculates and stores, as a correction table (e.g., lookup table (LUT)), correction data 411 of the linearity error. As illustrated, the correction data 411 is calculated as a difference between an output shaft encoder characteristic 401 and a motor encoder characteristic 403 for a plurality of small sections (a plurality of phase angle sections on the output shaft).

FIG. 5 is a flowchart showing the process of the tilt (pan) correction unit. The process is executed when the operation in the adjustment mode is selected by the user, for example.

In S501, the tilt correction unit 174 sets, to AbsEnc, the position information obtained from the output shaft encoder in the tilt direction. The position information at this time is set as a temporary coordinate origin position of MotEnc, which is position information on the motor encoder. Various parameters of SumDiff, n, and s are cleared to zero. Note that SumDiff is a cumulative difference, n is the number of sampling counts in one small section, and s is the number of counts in a processed small section. In S502, the tilt correction unit 174 drives a tilt motor to move the tilt direction of the camera head 110 to the lower end. In S503, the tilt correction unit 174 drives the tilt motor to start moving the tilt direction of the camera head 110 at a constant speed toward the upper end.

In S504, the tilt correction unit 174 performs sampling of correction data. As data sampling, the position information on the output shaft encoder is set to AbsEnc, and the position information on the motor encoder is set to MotEnc. Furthermore, the difference between the both is set to diff, and diff is added to SumDiff. In S505, the tilt correction unit 174 determines whether or not the tilt direction of the camera head 110 has moved (entered the next small section) from the small section at which sampling is performed in S504. The process returns to S504 if the camera head 110 has not moved, and the process proceeds to S506 if the camera head 110 has moved to the next small section.

In S506, the tilt correction unit 174 calculates an average value of a plurality of diff obtained in a small section. In S507, the tilt correction unit 174 stores the average value calculated in S506 in the correction table (LUT) in association with AbsEnc as correction data for a small section s.

In S508, the tilt correction unit 174 determines whether or not the tilt direction of the camera head 110 reaches the upper end. The process returns to S504 if the upper end has not been reached, and the process ends if the upper end has been reached.

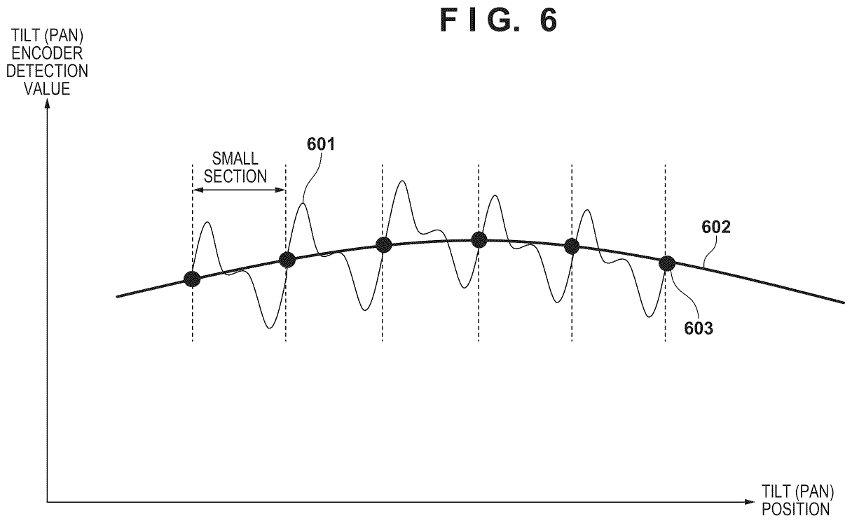

FIG. 6 is a view describing the averaging process (S506) in small sections in the tilt (pan) correction unit. As described above, the output shaft encoder obtains angle information by performing arc tangent conversion on sine wave signals having the three types of periods of upper, middle, and lower. Therefore, if the sine wave signal has distortion, a periodic fluctuation (ripple) as indicated by a curve 601 occurs in the angle information obtained corresponding to the tilt position. This periodic fluctuation is difficult to correct because the shape and phase thereof fluctuate due to a change in environment. Therefore, small sections corresponding to N times (N is a natural number) the period of the ripple are determined, a plurality of differences (diff) are calculated in each small section, and an average value 603 of the plurality of differences is stored as correction data in the (representative position of) corresponding small section. A narrower phase angle range of each small section allows more correction data of the small section to be set. Therefore, here, the phase angle range of each small section corresponds to one period of the ripple.

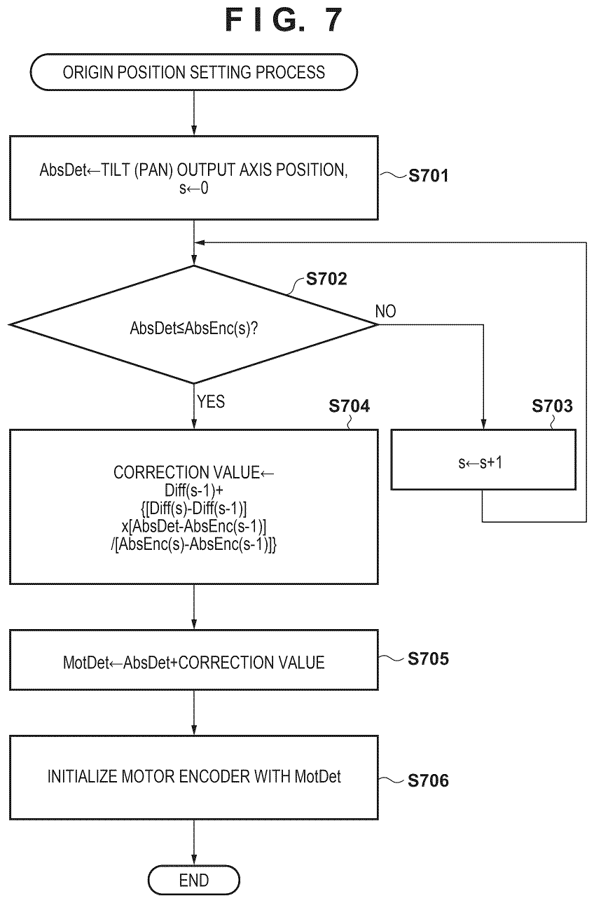

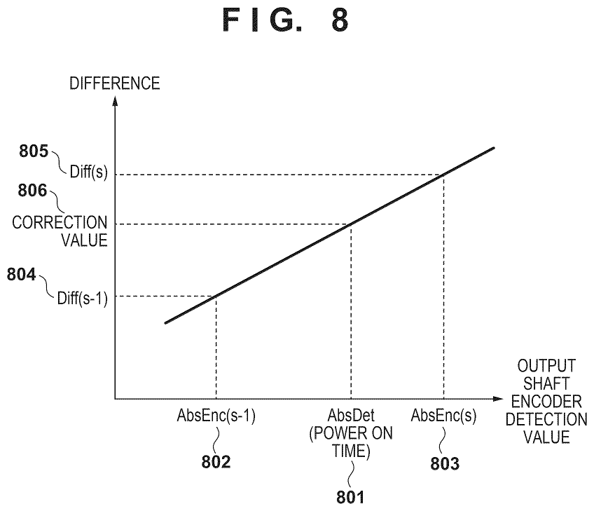

Next, the setting of the coordinate origin position of the motor encoder when the power is on will be described with reference to FIGS. 7 and 8.

FIG. 7 is a flowchart showing the process of the tilt (pan) setting unit. The process is executed when the power is turned on, for example.

In S701, the tilt setting unit 175 sets, to AbsDet, the position information obtained from the output shaft encoder in the tilt direction.

In S702, the tilt setting unit 175 compares AbsEnc(s) corresponding to the small section s in the correction table with AbsDet. When AbsDet≤AbsEnc(s) is satisfied, the process proceeds to S704, and otherwise, s is incremented in S703, and a small section of interest is moved. This process specifies the small section s where AbsEnc(s−1)<AbsDet≤AbsEnc(s) is satisfied.

In S704, the tilt setting unit 175 calculates a correction value 806 corresponding to the tilt position of AbsDet. Here, it is assumed to perform linear interpolation, but the correction value 806 may be calculated by another known interpolation technique.

FIG. 8 is a view describing linear interpolation in the tilt (pan) setting unit. As described above, the small section s specified in S702 satisfies AbsEnc(s−1)<AbsDet≤AbsEnc(s). As described above, AbsEnc(s) and Diff(s) corresponding to the small section s are stored in the correction data. Therefore, the correction value 806 corresponding to AbsDet is calculated by linear interpolation using Diff(s−1) and Diff(s).

In S705, the tilt setting unit 175 corrects AbsDet using the correction value 806 and sets it to MotDet. In S706, the tilt setting unit 175 executes setting (initialization process) of the coordinate origin position of the motor encoder with the position information MotDet that is corrected (corrected position information).

As described above, according to the first embodiment, the correction table based on the difference (error) between the detection value of the absolute value encoder of the output shaft and the detection value of the motor encoder of the motor shaft is derived. When the coordinate origin position of the motor encoder is set (initialization process), the detection value (AbsDet) of the output shaft encoder is corrected with reference to the correction table. This enables the initialization process in which the influence of the linearity error in the absolute value encoder is reduced. This enables high-accuracy position control of the motorized camera platform.

Note that in the first embodiment described above, the position (phase angle) control of the motor used for the camera platform (pan/tilt) of the remote camera has been described. However, the present disclosure is also applicable to any other apparatus/system in which a motor is used to control the position of a movable part, and a relative value encoder and an absolute value encoder are used in combination.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-124835, filed Jul. 31, 2024, which is hereby incorporate by reference herein in its entirety.

What is claimed is:

1. A control apparatus that drives a movable part using a motor, the control apparatus comprising:
a first reception unit that receives absolute position information on an output shaft that is a rotation axis of the movable part;
a second reception unit that receives relative position information on a motor shaft that is a rotation axis of the motor;
a generation unit that generates correction data corresponding to a plurality of positions of the output shaft based on the absolute position information and the relative position information;
a setting unit that sets an origin position of the relative position information based on the absolute position information; and
a drive signal generation unit that generates a drive signal for the motor using the relative position information based on the origin position, wherein
the setting unit sets the origin position based on corrected position information in which the absolute position information is corrected based on the correction data.

2. The control apparatus according to claim 1, wherein
the first reception unit receives the absolute position information from a first encoder that detects a phase angle of the output shaft, and
the second reception unit receives the relative position information from a second encoder that detects a rotation angle of the motor shaft.

3. The control apparatus according to claim 2 further comprising
a conversion unit that converts the relative position information into converted position information in a position coordinate of the output shaft, wherein
the generation unit generates the correction data based on a difference between the absolute position information and the converted position information.

4. The control apparatus according to claim 3, wherein
rotation of the motor shaft is transmitted to rotation of the output shaft by meshing between a motor gear coupled to the motor shaft and a driving gear coupled to the output shaft, and
the conversion unit converts the relative position information into the converted position information based on a ratio of resolution of the first encoder to resolution of the second encoder when the output shaft rotates by a unit angle.

5. The control apparatus according to claim 3, wherein
each of the plurality of positions is a respective representative position of a plurality of phase angle sections of the output shaft, and
the generation unit calculates a plurality of the differences for each of the plurality of phase angle sections, and generates an average value of the plurality of calculated differences as correction data corresponding to a representative position of a corresponding phase angle section.

6. The control apparatus according to claim 5, wherein
the absolute position information output from the first encoder fluctuates periodically with respect to a change in an absolute position of the output shaft, and
the phase angle section is determined based on a period of the fluctuation.

7. The control apparatus according to claim 6, wherein
the phase angle section is a section corresponding to one period of the period of the fluctuation.

8. The control apparatus according to claim 1, wherein
the movable part is an image capturing apparatus, and
the motor is a pan drive motor or a tilt drive motor for changing a capturing direction of the image capturing apparatus.

9. A control method for a control apparatus that drives a movable part using a motor, the control method comprising:
receiving absolute position information on an output shaft that is a rotation axis of the movable part;
receiving relative position information on a motor shaft that is a rotation axis of the motor;
generating correction data corresponding to a plurality of positions of the output shaft based on the absolute position information and the relative position information;
setting an origin position of the relative position information based on the absolute position information; and
generating a drive signal for the motor using the relative position information based on the origin position, wherein
in the setting, the origin position is set based on corrected position information in which the absolute position information is corrected based on the correction data.

10. A non-transitory computer-readable recording medium storing a program that, when executed by a computer, causes the computer to perform a control method for a control apparatus that drives a movable part using a motor, the control method comprising:
receiving absolute position information on an output shaft that is a rotation axis of the movable part;
receiving relative position information on a motor shaft that is a rotation axis of the motor;
generating correction data corresponding to a plurality of positions of the output shaft based on the absolute position information and the relative position information;
setting an origin position of the relative position information based on the absolute position information; and
generating a drive signal for the motor using the relative position information based on the origin position, wherein
in the setting, the origin position is set based on corrected position information in which the absolute position information is corrected based on the correction data.
